(19) United States
(12) Patent Application Publication
(10) Pub. No.: US 2001/0002022 A1
(43) Pub. Date: May 31, 2001

(54) HYBRID STEEL/FIBERGLASS UNDERGROUND STORAGE TANK

(76) Inventors: ERICH CONRAD STEINBERGS, MINNEAPOLIS, MN (US); JOHN STEINBERGS, EXCELSIOR, MN (US)

Correspondence Address: MERCHANT & GOULD, P O BOX 2903, MINNEAPOLIS, MN, 55402-0903, US

(21) Appl. No.: 09/397,408

(22) Filed: Sep. 16, 1999

Related U.S. Application Data
(60) Provisional application No. 60/100,482, filed on Sep. 16, 1998.

(51) Int. Cl. F17C 1/06

(52) U.S. Cl. 220/567.1; 220/567.2; 220/589

(57) ABSTRACT

A hybrid fiberglass/steel underground storage tank that combines the advantages of a fiberglass tank with those of a steel tank and can be used with various monitoring systems. The tank includes an interior portion made of steel and an exterior portion made of fiberglass. The exterior portion has at least one resin and glass layer, preferably formed of chopped glass mat and 100% solids epoxy resin, coupled to a spacer formed of a three-dimensional woven glass fabric, such as Parabeam®. The interior steel portion and the exterior fiberglass portion are integrally formed to create a single structure. A method of making a hybrid tank is also described.

This invention is directed to an underground storage tank for storing petroleum products and the like and, more specifically, to an underground storage tank having an interior portion formed of steel and an exterior portion formed of fiberglass.

### BACKGROUND OF THE INVENTION

Standard steel underground tanks may be undesirable for storing fuel (and other materials) because the steel can corrode or otherwise deteriorate over time, resulting in fuel leakage. Further, in light of the potential hazards imposed by fuel leakage, it is preferable to use (and, in fact, required by the government in many circumstances) double-wall storage tanks that can be monitored interstitially, that is, within a plurality of space(s) formed between the two walls. Such monitoring systems typically employ a fluid monitoring material and a sensor. A double-walled steel tank does not permit the use of one of the most commonly-used fluid monitoring materials, brine, because the brine itself will corrode the tank.

In view of the above, fiberglass tanks are often used instead of steel tanks. However, fiberglass tanks can suffer from a potential drawback in that they might be damaged by fuel additives such as solvents, materials to which steel tanks generally show greater resistance and durability.

### SUMMARY OF THE INVENTION

The present invention overcomes the disadvantages of the prior art by providing an underground storage tank with an interior portion formed of steel and an exterior portion formed of double-wall fiberglass with a spacer interposed between the fiberglass walls to form an interstitial space. Alternatively, a single-wall of fiberglass may form the exterior portion with a spacer material interposed between the steel tank forming the interior portion and the outer fiberglass wall. In either embodiment, the interior and exterior portions of the tank are integrally formed to create a single, hybrid steel/fiberglass tank.

A tank according to a first embodiment is constructed of a first layer or “structure” adhered to the exterior wall of a steel tank portion. This first layer is preferably made of resin and glass fibers. A primer layer of resin may be included between the steel tank portion and the first layer to improve adhesion of the first layer to the steel tank portion. On the exterior of the first layer is a spacer formed of a resin-impregnated core, preferably using a three-dimensional woven glass fabric material such as Parabeam®, disclosed in U.S. Pat. No. 5,534,318, the contents of which are incorporated herein by reference. A second resin and glass fibers layer or “structure” is bonded to the spacer so that the spacer forms an interstitial space between the first and second resin and glass fibers layers. A particular advantage to the use of the Parabeam® spacer is that, when the resin sets, the outer planes of the Parabeam® material pull apart with the pile threads connecting in a multiplicity of places to form “columns” around which fluid channels are created. This allows a monitoring fluid, discussed in more detail below, to flow evenly around the entire tank. Also, the Parabeam® spacer adds structural strength to the hybrid tank, which allows the interior portion to be constructed of thinner, lighter weight steel, thus reducing weight and cost.

In a second preferred embodiment, the interior portion of the hybrid tank, that is, the portion formed of a steel tank, is sprayed with resin and the spacer of Parabeam® is applied directly to the outside of the resin-coated steel tank. A resin and glass layer as in the first preferred embodiment is then applied to the spacer so that an interstitial space is formed between the interior steel portion and the exterior fiberglass portion. Again, as in the first preferred embodiment, the exterior fiberglass portion and the interior steel portion are integrally formed to form a single, hybrid tank.

### BRIEF DESCRIPTION OF THE DRAWINGS

The above features of the present invention are evident from the attached drawing in which:

FIG. 1 is a side-elevational view of a hybrid tank according to a first embodiment of the present invention;

FIG. 2 is a cutaway, cross-sectional view of a portion of FIG. 3;

FIG. 3 is a cross-sectional view of the tank shown in FIG. 1;

FIG. 4 is a partial, cross-sectional view of a hybrid tank showing a collar and manway;

FIG. 5 is a partial, cross-sectional view of a hybrid tank showing a fitting; and

FIG. 6 is a partial, cross-sectional view of a hybrid tank showing a monitoring reservoir according to another preferred embodiment of the present invention.

### DETAILED DESCRIPTION OF THE INVENTION

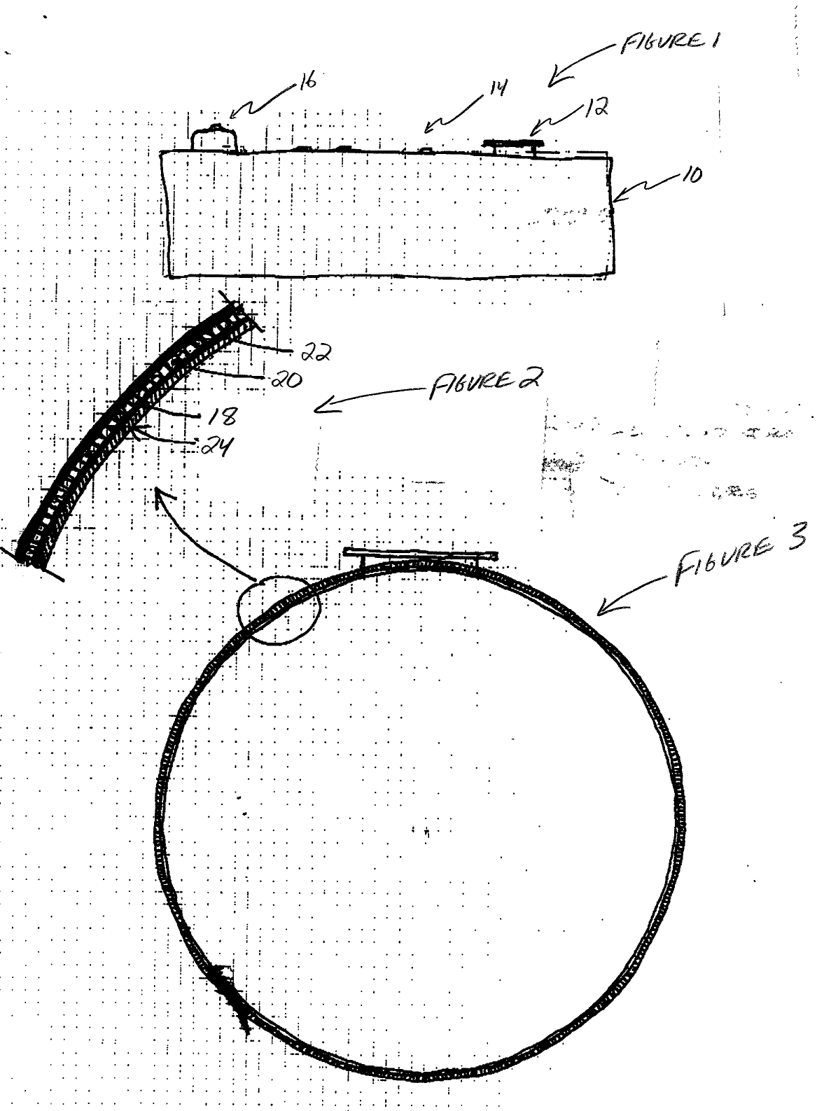

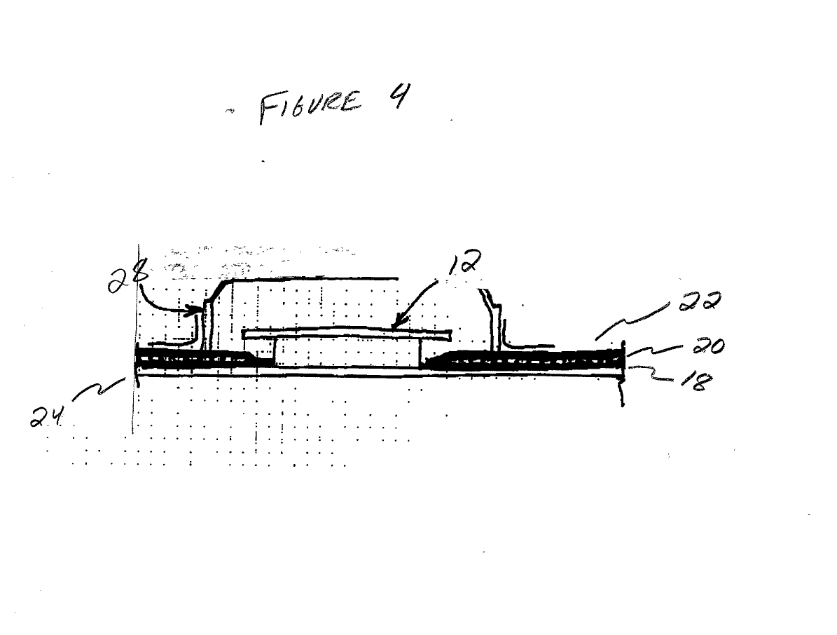

A hybrid steel/fiberglass underground storage tank in accordance with the present invention is shown in FIG. 1 and generally designated 10. Throughout the application, like numbers are used to represent like elements. Although the tank shown in FIG. 1 is cylindrical, this is not intended to be limiting as the invention may be applied to tanks of a variety of shapes. In fact, it is envisioned that the present invention may be used in containment environments other than underground tanks, such as underground aquifers and the like. Tank 10 typically holds a petroleum product such as fuel oil or gasoline, but may contain other types of products including water, as long as the interior wall of the storage tank does not contaminate the product held therein and the product does not cause the interior wall to degrade or deteriorate. Tank 10 may have a manway 18, fitting 20, and a reservoir 22.

In general, tank 10 includes a first resin layer 18 and a second resin layer 22 over an existing steel tank 24. First and second resin layers 18, 22 preferably are made of 100% solids epoxy resin. In another preferred embodiment, a resin, such as the 100% solids epoxy resin includes glass mat applied thereto. The glass mat may be applied by hand in a manner to be discussed in more detail below. Alternatively, a prepared glass mat with resin preimpregnated therein may be used. It is envisioned that other resins may be used as well, including but not limited to, various other heat-cured and UV light-cured resins. Layers 18, 22 ultimately form the new walls or “shells” of the tank in accordance with the present invention.

In one embodiment, a spacer 20 is sandwiched between resin layers 18, 22. Spacer 20 is preferably made of a resin-impregnated core such as Parabeam®, a three-dimensional woven glass fabric. This material is particularly advantageous because, when sandwiched between resin layers 18, 22, the threads connecting the upper and lower planes of the cloth stiffen to form a multiplicity of “columns” perpendicular to resin layers 18, 22 with interstitial spaces therebetween. The columns define parallel channels that allow fluid to flow therein. In addition, since the individual columns defining a wall of a given channel are spaced, flow between channels is permitted. The interstitial spaces thus formed readily accommodate a monitoring system for leak detection.

While the use of Parabeam® has been found to be particularly advantageous, it is to be understood, of course, that other suitable materials may be used for spacer 20, as long as the material forms a monitorable interstitial space between resin layers 18, 22. The particular material used must also adhere in a suitable manner to resin layers 18, 22 to form a single, integral structure.

Alternatively, in a second preferred embodiment, the interior portion of the hybrid tank, that is, the portion formed of a steel tank, is sprayed with resin and the spacer of Parabeam® is applied directly to the outside of the resin-coated steel tank. A resin and glass layer as in the first preferred embodiment is then applied to the spacer so that an interstitial space is formed between the interior steel portion and the exterior fiberglass portion. Again, as in the first preferred embodiment, the exterior fiberglass portion and the interior steel portion are integrally formed to form a single, hybrid tank.

A primer resin layer (not shown) may be formed between the tank 10 and the first resin layer 18 to improve the adherence or contact between the existing tank wall and first resin layer 18. The primer layer is preferably made of the same resin as used in layers 18, 22, but other suitable materials may be used. For example, resin layer 18 and/or 22 may include glass mat, while the primer layer may be made of 100% solids epoxy resin without any glass.

The exterior surface of the existing tank 10 should be prepared by abrasive blasting or the like and the tank walls should be repaired, if necessary. The tank is preferably prepared so that the metal finish is white and completely free of scale, rust and foreign matter. No water or chemical solutions that could inhibit the adherence of resin to the tank wall should be used.

The existing steel tank should be inspected for signs of structural failure, shell wall buckling or flattening, leakage around the seams, chemical degradation or large amounts of corrosion.

The location and type of interstitial space monitor is selected to accommodate the use of a particular tank. An appropriate monitor opening (not shown) should be made in the tank top prior to the application of any resin layer.

A primer layer may be applied to the outer wall of tank 10. The primer layer is preferably made of 100% solids epoxy resin and may be applied by an airless resin sprayer. A minimum thickness of 20 mils and a nominal thickness of 25 mils are preferred. The primer layer then should be cured to the barcol hardness recommended by the manufacturer. A heater may be used to accelerate the curing process. Alternatively, the primer layer may be made of a UV curable resin and ultraviolet (UV) lights may be used instead of a heater. It should be noted that this applies to each application of a resin or resin and glass layer.

Once the primer layer is completely cured, first resin layer 18 may be applied. In a preferred embodiment, first resin layer 18 is formed by spraying resin, such as 100% solids epoxy resin, over the entire surface of the primer layer. In another preferred embodiment, glass mat is first saturated with the resin and then applied by hand to exterior tank surfaces. Places where the mats join should be overlapped, preferably by 1 inch. The first and second resin and glass layers are preferably formed of chopped strand mat and 100% solids epoxy resin. The glass mat should be applied 360 degrees around the steel tank exterior and on both domes, excluding areas where fittings and manways are located. The glass mat should be rolled out to eliminate trapped air and then a layer of 100% solids epoxy resin should be applied to the mat, preferably using an airless spray gun. It has been found that two layers of 1.5 oz per sq. ft. fiberglass mat saturated with 100% solids epoxy resin in a ratio of 70% resin and 30% glass by weight is optimal. To ensure a durable outer shell of the exterior portion of the tank, the second resin and glass layer is preferably 0.040-0.080 inches thick. While the tank according to this preferred embodiment of the present invention has three distinct walls (formed by the first and second layers of the exterior portion and the steel wall of the interior portion), the entire hybrid tank is integrally formed to maximize structural integrity and strength. The glass layer may also be sprayed on or “chopped” using a chopper gun, resin, and gun roving.

A monitoring system may be used to monitor the interstitial space for leakage. The monitoring system may employ dry or wet monitoring. For example, a fluid such as brine may fill the interstitial space formed within the Parabeam® and a sensor may be used to detect any loss of fluid or change in fluid pressure. Alternatively a dry probe monitor could be used and located, for example, at the end of the tank. FIG. 6 illustrates a reservoir 16 for monitoring. An access hole 28 is drilled in the Parabeam® material. The reservoir 16 may be glassed to the outer layer 22.

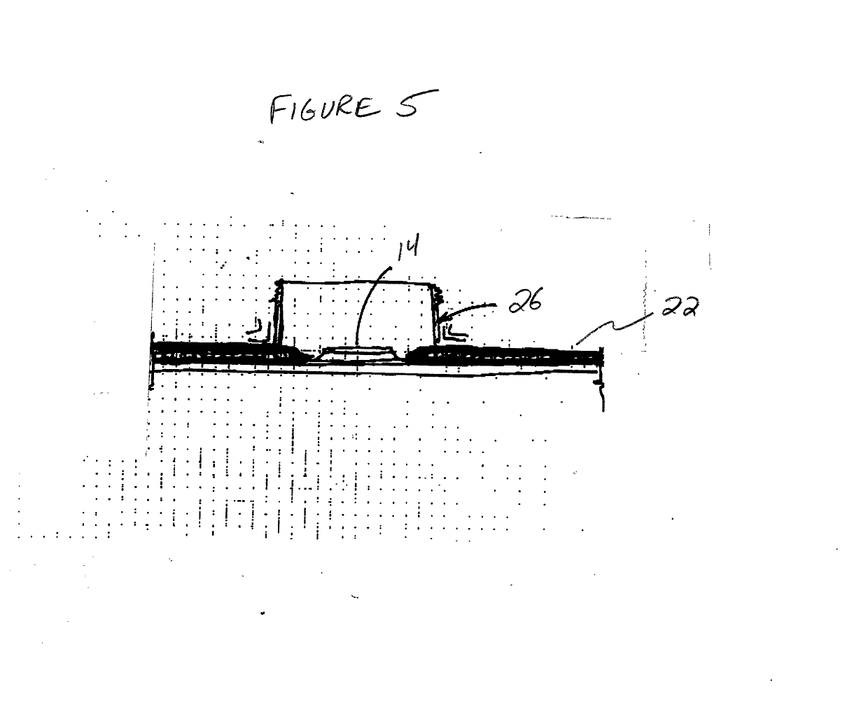

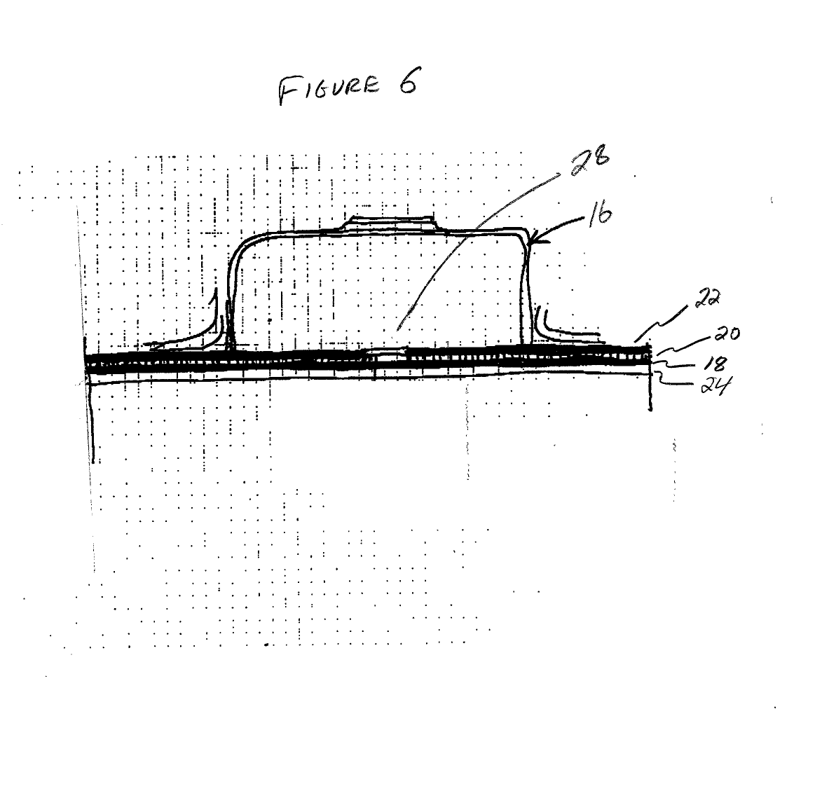

As shown in FIG. 4, a manway 12 may be attached, for example, by bolting the manway onto and/or glassing the manway into the hybrid tank 10 to provide access to the tank interior for maintenance or cleaning or the like. A collar 28 may be glassed to the outer layer 22. Also, suitable fittings 14 may be attached to the hybrid tank 10, as shown in FIG. 5. The fitting 14 should be glassed in place using standard fiberglass techniques, keeping the center portion open and free of resin and glass. A secondary housing 26 may be glassed to the outer layer 22.

If desired, a resin coat may also be applied to the interior of the steel tank portion to form a chemical liner for the product to be stored within the hybrid tank.

Because of the combination of fiberglass and steel in the hybrid underground storage tank according to the present invention, there is no need for cathodic protection as is ordinarily required with steel tanks.

As discussed in detail above, spacer 20 can be made of a resin-impregnated core, preferably of a three-dimensional woven glass fabric known as Parabeam®. Preferably the Parabeam® is hand-applied over the resin layer 18 with a resin and glass mixture in a ratio of 55% resin to 45% glass by weight. It is envisioned that the Parabeam® might be applied using a hand-tool such as a roller or using a custom-made machine thereby covering the resin layer 18. The material may be butt-jointed together instead of having overlapping seams. The seams may be covered by a stitch mat laminate, preferably a laminate of 0.75 oz. per sq. ft. glass mat and 8 oz. per sq. yd. woven roving material with a glass ratio of 40% glass and 60% resin by weight. Care should be taken so that the spacer 20 is not oversaturated with resin, which could cause the interstitial space to become clogged.

Once the spacer 20 is applied, second resin layer 22 may be applied in a manner discussed above with reference to first resin layer 18.

Once the final layer has cured and hardened to a barcol reading recommended by the manufacturer, a final air test may be conducted. This test may be conducted in a known manner by pressurizing the interstitial space for a period of time, for example, three hours, and monitoring the interstitial space for a loss in pressure. If a loss in pressure is detected, a material such as soap (or other surfactant or the like that will produce visible bubbles wherever air is leaking) may be applied to the exterior of the tank to locate the leak. Alternatively, the “soap method” alone may be used to test for leakage. In another alternative, the interstitial space might be pressurized by a colored, inert gas that could be visually detected within the tank cavity if any leaks exist.

The above is for illustrative purposes only. Modifications may be made, particularly with regard to size, shape and arrangement of parts. For example, the primer layer may be unnecessary, particularly if first and second resin layers 18, 22 do not contain any glass mat. Further, it is envisioned that complete secondary containment may be attained by installing a riser sump (or other type of containment housing) and double-wall piping. These examples should not be considered as limiting the invention, the scope of which is defined by the appended claims.

We claim:

1. A method of manufacturing a hybrid steel/fiberglass underground storage tank formed integral with an existing steel tank having an outer wall, said method comprising the steps of:
applying a first resin layer to said outer tank wall to form an inner wall of said hybrid tank;
applying a resin-impregnated core to said first layer;
applying a second resin layer to said resin-impregnated core to form an outer wall of said hybrid tank, each of said inner and outer walls being bonded to said resin-impregnated core, said resin-impregnated core forming an interstitial space between said inner and outer walls.

2. A method of claim 1 wherein said resin-impregnated core is a resin-impregnated, three-dimensional woven glass fabric.

3. A method of claim 2 wherein said resin-impregnated, three-dimensional woven glass fabric is Parabeam®.

4. A method of claim 1 wherein said first resin layer is 100% solids epoxy resin.

5. A method of claim 1 wherein said first resin layer further comprises fiberglass mat.

6. A method of claim 5 wherein said first resin layer includes fiberglass mat in a ratio of 60% resin to 40% glass mat by weight.

7. A method of claim 4 wherein said first resin layer is applied by spraying.

8. A method of claim 5 wherein said first resin layer is applied by spraying resin onto said inner tank wall and said fiberglass mat is applied manually.

9. A method of claim 1 further comprising the step of applying a primer resin layer prior to applying said first resin layer.

10. A method of claim 18 further comprising the step of abrasive blasting the outer tank wall prior to applying said first layer.

11. A method of claim 1 wherein said second resin layer is 100% solids epoxy resin.

12. A method of claim 1 wherein said second resin layer further comprises fiberglass mat.

13. A method of claim 12 wherein said second resin layer includes fiberglass mat in a ratio of 60% resin to 40% glass mat by weight.

14. A method of claim 1 wherein said second resin layer is applied by spraying.

15. A method of claim 12 wherein said second resin layer is applied by spraying resin onto said inner tank wall and said fiberglass mat is applied manually.

16. A method of claim 1 further comprising the step of installing an interstitial monitoring device.

17. A method of claim 1 further comprising the step of testing the interstitial space for leakage after said second resin layer is applied.

18. A hybrid steel/fiberglass underground storage tank formed integral with an existing steel tank, said hybrid tank comprising:
a first outer shell integrally formed integral with the outer wall of the existing underground storage tank, said outer shell including at least one resin layer;
a resin-impregnated core bonded to said outer shell;
a second outer shell bonded to said resin-impregnated core, said second outer shell including at least one resin layer, wherein said resin-impregnated core forms an interstitial space between said first and second outer shells.

19. A hybrid underground storage tank as in claim 18, wherein said resin-impregnated core is a resin-impregnated, three-dimensional woven glass fabric.

20. A hybrid underground storage tank as in claim 18 wherein said resin-impregnated, three-dimensional woven glass fabric is Parabeam®.

21. A hybrid underground storage tank as in claim 18 wherein said at least one resin layer of said outer shell is 100% solids epoxy resin.

22. A hybrid underground storage tank as in claim 18 wherein said at least one resin layer of said outer shell further comprises fiberglass mat.

23. A hybrid underground storage tank as in claim 22 wherein said at least one resin layer of said outer shell contains 60% resin and 40% glass mat by weight.

24. A hybrid underground storage tank as in claim 20 wherein said at least one resin layer of said outer shell is 100% solids epoxy resin.

25. A hybrid underground storage tank as in claim 20 wherein said at least one resin layer of said outer shell further comprises fiberglass mat.

26. A hybrid underground storage tank as in claim 25 wherein said at least one resin layer of said outer shell contains 60% resin and 40% glass mat by weight.

27. A hybrid underground storage tank as in claim 18 wherein said at least one resin layer of said inner shell is 100% solids epoxy resin.

28. A hybrid underground storage tank as in claim 18 wherein said at least one resin layer of said inner shell further comprises fiberglass mat.

29. A hybrid underground storage tank as in claim 28 wherein said at least one resin layer of said inner shell contains 60% resin and 40% glass mat by weight.

30. A hybrid underground storage tank as in claim 23 wherein said at least one resin layer of said inner shell is 100% solids epoxy resin.

31. A hybrid underground storage tank as in claim 30 wherein said at least one resin layer of said inner shell further comprises fiberglass mat.

32. A hybrid underground storage tank as in claim 31 wherein said at least one resin layer of said inner shell contains 60% resin and 40% glass mat by weight.

33. A hybrid underground storage tank as in claim 18 further comprising a primer resin between said outer shell and the inner wall of the existing tank.

34. A hybrid underground storage tank as in claim 33 wherein said primer resin is 100% solids epoxy resin.

35. A hybrid underground storage tank as in claim 18 further comprising an interstitial monitoring device.
